(19) United States
(12) Patent Application Publication
(10) Pub. No.: US 2015/0229734 A1
(43) Pub. Date: Aug. 13, 2015

(54) TRANSPARENT INTERNET CACHE AND METHOD FOR PROVIDING TRANSPARENT INTERNET CACHE

(71) Applicant: ELECTRONICS AND TELECOMMUNICATIONS RESEARCH INSTITUTE, Daejeon (KR)

(72) Inventors: Tae Yeon KIM, Daejeon (KR); Bhum Cheol LEE, Daejeon (KR)

(21) Appl. No.: 14/617,974

(22) Filed: Feb. 10, 2015

(30) Foreign Application Priority Data
Feb. 12, 2014 (KR) 10-2014-0016032

(51) Int. Cl. H04L 29/08; H04L 12/24; H04L 12/26

(52) U.S. Cl. CPC H04L 67/2852; H04L 43/0876; H04L 67/10; H04L 41/0806

(57) ABSTRACT

Provided herein is a method for providing a transparent internet cache function, the method including obtaining a traffic usage pattern by data analyzing from a cloud node in response to receiving a request for transparent internet cache provisioning in a transparent internet cache provisioning server; when installing a transparent internet cache in the cloud node is being determined, determining a method for branching traffic; determining a method for contents identification regarding the traffic branched in the method; determining whether or not to operate the transparent internet cache as a proxy server; generating the transparent internet cache by applying a cache in policy and cache replacement policy; and provisioning the transparent internet cache to the cloud node.

### CROSS-REFERENCE TO RELATED APPLICATION

This application claims priority to and the benefit of Korean Patent Application No. 10-2014-0016032, filed on Feb. 12, 2014, in the Korean Intellectual Property Office, the entire contents of which are incorporated herein by reference in their entirety.

### BACKGROUND

1. Field of Invention

Various embodiments of the present disclosure relate to a network system, and more particularly to a transparent internet cache and a method for providing a transparent internet cache function in a dispersed cloud environment.

2. Description of Related Art

Due to the rapid supply of the internet, the number of internet users is increasing significantly, and smart phones are becoming widespread together with mobile communication technologies. Thus, the current communication markets are transforming into gigantic contents distribution markets oriented around digital data services.

Therefore, as internet contents data such as user created contents (hereinafter referred to as ‘UCC’) are being increasingly used by numerous users and introduced into networks, demands are emerging for various ways to efficiently process the various needs of internet users who wish to use such internet contents data.

There is a representative method for using such internet contents data: a method for using the contents delivery network (hereinafter referred to as ‘CDN’) technology. In the CDN technology, a CDN server is dispersed and forward-deployed in an area or communication operator region in order to disperse the load of the server, reduce network load for services, and increase user quality in response to demand for contents being concentrated in a certain server or server cluster. By doing this, the CDN technology allows users' requests for contents to be processed in a nearby CDN server.

Recently, the on-net CDN or Telco CDN model have been developed where communication operators may efficiently disperse contents on communication networks using the CDN technology in order to satisfy QoE (Quality of Experience) of users.

This CDN technology may be applied to management-type use of contents wherein contents obtained or produced may be distributed on networks by CDN operators. That is, effects of the CDN technology may occur through operator portals as long as the contents are identifiable and the locations of distribution are precisely identifiable.

However, it is difficult for CDN operators to distribute and identify numerous contents such as UCC that have been produced and distributed by numerous unspecified people in networks, and it is also difficult to respond to each of the different patterns of users that change frequently.

Meanwhile, cloud services are being provided by communication operators in order to efficiently distribute and provide cloud resources based on communication networks. The communication operator-based cloud nodes that have their bases on communication operators or operators who provide cloud services are dispersed near cloud service users in order to take into account the local characteristics and disperse the load concentration.

When providing contents services in such a dispersed cloud environment, traffic loads with external networks must be reduced as much as possible so as to minimize network costs and to enhance the service quality of service users. However, introduction of unmanaged type contents such as UCC into a dispersed cloud environment increases network traffic load, and causes repetition of contents and concentration of service requests on certain services, thereby deteriorating the service quality of service users.

### SUMMARY

A purpose of various embodiments of the present disclosure is to provide a transparent internet cache and a method for provisioning a transparent internet cache function capable of improving repetitive use and abuse of networks caused by introduction of unmanaged type contents in a dispersed cloud environment.

Another purpose of the various embodiments of the present disclosure is to provide a transparent internet cache and a method for provision a transparent internet cache function capable of virtualizing a transparent internet cache function in a dispersed cloud environment, and of dispersing and providing the function in a format intended by a service provider.

According to an embodiment of the present disclosure, there is provided a method for provisioning a transparent internet cache function, the method including obtaining a traffic usage pattern by data analyzing from a cloud node in response to receiving a request for transparent internet cache provisioning in a transparent interne cache provisioning server; when installing a transparent internet cache in the cloud node is being determined, determining a method for branching traffic; determining a method for contents identification regarding the traffic branched in the method; determining whether or not to operate the transparent internet cache as a proxy server; generating the transparent internet cache by applying a cache in policy and cache replacement policy; and provisioning the transparent internet cache to the cloud node.

In the embodiment, the obtaining the traffic usage pattern may include provisioning a transparent traffic monitoring function to the cloud node; and obtaining the traffic usage pattern through data branching and data analyzing by the transparent traffic monitoring function.

In the embodiment, the traffic usage pattern may include information on at least some of an address of departing point, address of destination, protocol, uniform resource identifier (URI), traffic type, and frequency.

In the embodiment, the determining a method for branching traffic may include selecting a number and capacity of the transparent internet cache.

In the embodiment, the determining a method for branching traffic may include selecting an area for selecting the transparent internet cache.

In the embodiment, the determining a method for branching traffic may include selecting one of a request-based mode and response-based mode of the transparent internet cache, and the request-based mode may operate based on a message of request by a client, and the response-based mode may operate based on a message of response by a server.

In the embodiment, the determining a method for branching traffic may include determining a redirecting rule for branching the traffic.

In the embodiment, the cache in policy may be determined based on a same amount of contents demanded during a preset period of time.

In the embodiment, the cache replacement policy may determine a maximum caching period of the cached contents.

According to another embodiment of the present disclosure, there is provided a transparent internet cache including a redirector for redirecting traffic between a client and server; a contents analyzer for configuring contents identification information through analyzing of contents introduction information included in the traffic; a cache in handler for storing contents in the cache in response to contents for which cache has been requested being delivered; a cache out handler for extracting the contents stored in the cache in response to a request for the contents stored in the cache being made; a server interface for managing session connection with the server, and receiving contents to the provided to the client; and an end user interface for managing a client session such that the contents transmitted from the server and the contents stored in the cache are provided to the client.

In the embodiment, the redirector may perform routing in units of flow.

In the embodiment, the contents analyzer may operate in one of a request-based mode and response-based mode, and the request-based mode may operate based on a message of request by the client, and the response-based mode may operate based on a message of response by the server.

In the embodiment, the cache in handler may prepare meta data for the stored contents, and the meta data may be used for repair and maintenance of the cache where the contents are stored.

In the embodiment, when transmitting cached contents to the client, the server interface may stop a session with the server, and may maintain connection with the client.

The transparent internet cache provisioning method according to the aforementioned various embodiments of the present disclosure is capable of provisioning a transparent interne cache to a cloud node in a dispersed cloud environment, thereby improving repetitive use and abuse of networks even when unmanaged type contents are introduced. Furthermore, it is possible to virtualize a transparent interne cache function in a dispersed cloud environment, and disperse and provide the function in a format intended by a service provider.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a view illustrating an operation of a transparent internet cache function according to an embodiment of the present disclosure;

FIG. 2 is a flowchart illustrating an operation of provisioning a transparent internet cache according to an embodiment of the present disclosure; and

FIG. 3 is a view for explaining an operation of provisioning a transparent internet cache to a dispersed cloud environment according to an embodiment of the present disclosure.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, ‘and/or’ may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

The present disclosure provides a method for provisioning a transparent internet cache function so as to provide high quality unmanaged type contents at a rapid speed in a dispersed cloud environment. In order to provide contents being introduced from outside that are unmanaged type contents, the present disclosure caches the contents in an intellectual method. By the aforementioned, when a request for the same contents is received from a service user, it is possible to provide a transparent internet cache function that provides contents from an internal cache while maintaining the connection with an external service.

Herein, the transparent interne cache function is a function that dynamically caches the data needed in a network between a contents provider and contents user and provides the contents to the user, while maintaining the relationship between the contents provider and contents user.

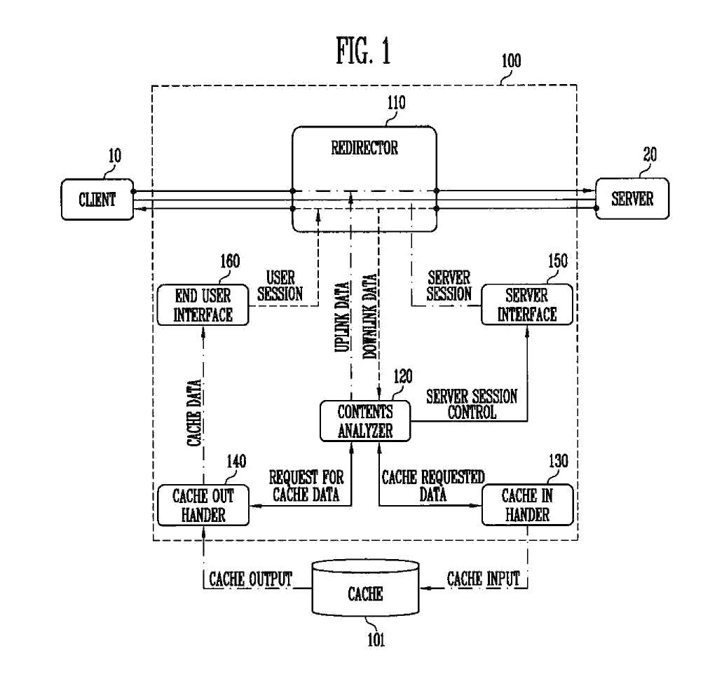

FIG. 1 is a view illustrating an operation of a transparent internet cache function according to an embodiment of the present disclosure.

Referring to FIG. 1, a function of a transparent internet cache 100 is provided between a client 10 and server 20. Herein, the client 10 may be a contents user, and the server 20 may be a contents provider.

The transparent interne cache 100 includes a redirector 110, contents analyzer 120, cache in hander 130, cache out hander 140, server interface 150, and end user interface 160. Furthermore, the transparent internet cache 100 may input or output data using a cache 101.

The redirector 110 branches certain network traffic in order to extract data between the client 10 and server 20. In order to branch the network traffic, the redirector 110 may use a policy based routing (PBR) or a flow unit routing method such as openflow of a software define network.

The contents analyzer 120 analyzes contents introduction information, and configures contents identification information for identifying the contents. There are two modes that the contents analyzer 120 may operate in: a request-based mode and response-based mode.

The request-based mode is a mode for performing a caching operation according to an analysis on a request message of a request by the client 10. The request-based mode must be managed by mapping the request by the client 10 and a response message and session from the server 20. Information on contents requested by the client 10 may be analyzed to form a contents request table. When a same contents request is made to the contents request table for more than a certain times within a certain period, such contents become contents subject to transparent internet cache. At a request by the client 10, information on mapping with a session must be maintained, and a corresponding response session message may be demanded for caching.

Meanwhile, the response-based mode is a mode that operates based on a response message. In this mode, a request by the client 10 is not processed, but a response message from the server 20 is analyzed so that in a case where a same response is received for more than a certain times in a certain period the contents automatically becomes subject to caching. Herein, the caching subject is recorded in the contents response table.

In the cache in hander 130, contents storing starts when contents for which caching has been requested is received, and a storage address and the cached contents table are recorded. When the storing in the cache 101 is completed, meta data regarding the cache data is prepared. Then, the meta data may be used in repair and maintenance of the cache 101.

The cache out hander 140 confirms whether or not certain contents are stored in the cache 101. Upon confirming that the contents are cache contents, the cache out hander 140 searches and extracts the cache contents. The cache out hander 140 transmits the extracted contents, and confirms contents information before a transmission is made. To do this, the cache out hander 140 may selectively perform a suitability procedure where it receives a certain size of contents from the server 20 and compares them with the data stored in the cache 101.

The server interface 150 performs management of session connection with the server 20. In the transparent internet cache 100, connection with the client 10 must be maintained that is necessary for additional information such as connection with the server 20, certification, other statistics, and charging.

Therefore, in a case where a connection request is made by the client 10 for a service, the service interface 150 transmits a packet so as to engage a TCP session. Also when a request is made for cached contents, the server interface 150, at one end of the transparent internet cache 100, relays a service request packet to the server 20 performs functions of certification, statistics and maintaining session connection. Then, when transmitting the cached contents to the client 10, the server interface 150 stops the session with the server 20, and maintains the connection with the client 10 to obtain an effect of transparent caching.

When successive-receiving is necessary to continuously provide partially cached contents to the user, the server interface 150 may relay such that a session connection is generated dynamically. In a case where a server type transparent internet cache 100 plays a role of a proxy of the server 20, it is possible to separate the session from the user session by a remote server. In such a case, in session connection with the server 20, it is possible to select whether to connect a session using an IP of the user (or the client (10)) or the IP of the transparent interne cache server. Herein, the transparent internet cache server refers to a server (or cloud node) where the transparent internet cache 100 is embodied.

The end user interface 160 must transmit data consistently regardless of whether it is data cached to the client 10 or transmitted from the server 20. The end user interface 160 must transparently provide to the client 10 a TCP session connection for contents provision. The end user interface 160 may jump in contents such as video by the client 10 and play the video, or even when replaying after a halt, transparently provide necessary session connection or data transmission. Furthermore, when intending to selectively use a transparent cache server instead of the server 20, the end user interface 160 may expose to the client 10 an address of the transparent internet cache server using an HTTP redirection function and so forth.

Hereinafter, an operation of the transparent interne cache 100 is explained in detail.

The redirector 110 branches uplink data being transmitted from the client 10 to the server 20 and outputs the branched uplink data to the contents analyzer 120. Furthermore, the redirector 110 branches downlink data being transmitted from the server 20 to the client 10 and outputs the branched downlink data to the contents analyzer 120.

The contents analyzer 120 analyzes contents introduction information, and configures contents identification information for identifying the contents. By doing this, the contents analyzer 120 determines cache data (that is, contents), and outputs information on the cache data to the cash in handler 130. The contents analyzer 120 requests for the cached cache data to the cache out handler 140. Furthermore, the contents analyzer 120 may control server session through the server interface 150.

The cache in handler 130 may store cache data in the cache 10, and generate meta data regarding the cache data.

The cache out hander 140 confirms whether or not the cache data has been cached according to a cache data request by the contents analyzer 120. When wanted cache data has been cached in the cache 10, the cache out hander 140 outputs the cached data to the end user interface 160.

The server interface 150 manages session connection of the client 10 and server 20.

The end user interface 160 manages a user session such that data transmitted from the server 20 or cache data from the cache 101 may be supplied to the client 10.

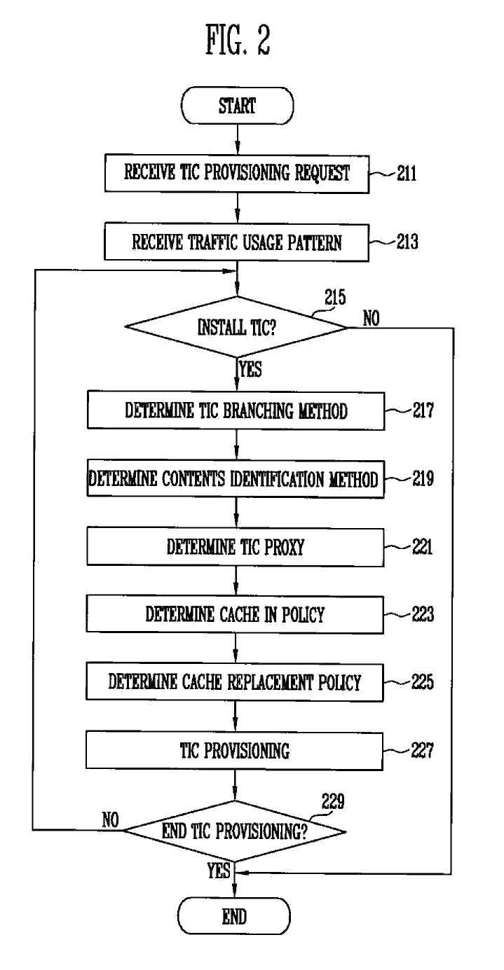

FIG. 2 is a flowchart illustrating an operation of provisioning a transparent internet cache according to an embodiment of the present disclosure.

Prior to referring to FIG. 2, it is to be noted that the transparent internet cache function in a dispersed cloud environment may be provisioned at a request by a user (that is, service provider).

Hereinafter, a selecting function at, a request by the service will be explained in detail.

First of all, it has a function of selecting the number and capacity of the transparent internet cache. The allocating range of the resources of a dispersed node and whether or not to use a load balancer may be determined depending on the number and capacity of the transparent internet cache.

Secondly, it has a function of selecting a transparent internet cache area. Whether or not to apply the transparent internet cache function may be determined depending on certain areas.

Thirdly, it has a function of selecting a mode (request or response). Whether to perform caching based on a request for contents or a response of contents by the server is determined depending on the mode of the transparent internet cache.

Herein, in the case of a request-based mode, counting is made based on a message of request by the client (that is, the user). Therefore, branching of uplink data is necessary, and the structure must be such that a session may be easily terminated in the middle of the contents user and contents server and such that the session between the terminals may be easily controlled in an interlocked manner. Therefore, data branching is used in the user's perspective such as branching based on a user IP or based on an address of a destination of the message of request for contents and so forth.

On the other hand, in a case of the response-based mode, branching is made only in a direction from a certain server to only one direction of responding. By doing this, the response-based mode has a structure of a single direction of caching contents of high frequency that corresponds to a certain pattern. Although the structure is simple, they are based on a response message from the server, and thus there is a disadvantage of it being difficult to use contents request information such as branching by a certain user. However, since the mode uses a simple branching structure, it has an advantage of easy embodiment.

Fourthly, it has a function of selecting redirecting tools (Src IP, Dest IP, protocol and so forth). That is, it is possible to determine a data branching rule for transparent internet caching. When rules such as a user's IP, address of destination, or certain protocol message that can be references of branching are set, they become references for uplink or downlink branching at a data branching point. In the case of a request-based mode, both an uplink rule and a downlink rule may be applied, but in the case of a response-based mode, only a downlink rule may be applied.

Fifthly, it has a function of selecting contents identification (Content Identification (Request URI (Uniform Resource Identifier) Hashing)). Rules for identifying corresponding contents are set through data analyzing of the branched message. For example, hash functions of request URI data or rules related to configuration of a hash table may be determined. A contents identifier may be an index for calculating frequency of contents and a key value of contents to be cached subsequently.

Sixthly, it has a function of selecting proxy/reverse proxy. Herein, proxy/reverse proxy is determined depending on a contract relationship between a transparent internet cache server and origin contents server. For example, when the interne cache server is designated as a proxy server of the origin contents server, all operations of the transparent internet cache are made in the same manner as the origin contents server. The transparent internet cache is interlocked with the transparent internet cache server using a message such as an HTTP (Hypertext Transfer Protocol) redirect, for instance, and receives serves, and the transparent interact cache server may perform the function as a reverse proxy of bringing contents in an interlocked manner with the origin contents server.

Seventhly, it has a function of selecting a cache-in policy (monitoring duration, count of appearance). This is a reference for determining whether or not to cache the contents, wherein how much same contents are requested for a certain period of time must be monitored. To do this, monitoring duration and count of appearance may be set. Different references may be applied to each of the request-based mode and response-based mode.

Eighthly, it has a function of selecting, a cache replacement policy (Aging, LRU, LFU and so forth). A maximum caching duration may be set for the cached contents, and a replacement policy is needed depending on standards such as managerial purpose, performance, and capacity and so forth. Herein, a least recently used (LRU) or least frequency used (LFU) may be applied as a replacement policy.

According to the present disclosure, a cloud service provider may provide a service where the transparent internet cache function is virtualized and leased. Hereinafter, an operation of provisioning the transparent internet cache for the aforementioned purpose will be explained in detail.

Referring to FIG. 2, a request for provisioning a transparent internet cache is made (step 211).

When the transparent internet cache provisioning is requested, the transparent internet cache provisioning server provisions to the cloud node only the transparent traffic monitoring function for the contents service provider to analyze the causes behind quality and cost increase. Herein, the transparent traffic monitoring function may install only the data branching function for analyzing traffic between the service user and network and data analyzing function in the cloud node and operate the same.

By doing this, the transparent internet cache provisioning server receives a traffic usage pattern from each of the cloud nodes (step 213). The transparent traffic monitoring function provisioned to the dispersed cloud nodes has a role of redirecting the traffic in order to analyze the service request message and service response message. Herein, the service response message is a message corresponding to the service request message. Furthermore, the transparent traffic monitoring function does not affect the interlocked operation between the service user and service provider, but only has a purpose of collecting data thereof.

The transparent internet cache provisioning server determines a branching method. Herein, the branching method may be selectively determined in various methods for each of the uplink traffic and downlink traffic. For example, the transparent internet cache provisioning server may determine such that branching is made for all traffic, packets of an address of a certain destination (that is, traffic), or only certain HTTP 80 port traffic.

The transparent interne cache provisioning server selectively determines a monitoring branching method by the convents service provider.

When a branching method is determined, selected traffic is branched by methods such as policy based routing (PBR) or software defined network (SDN) and then introduced into the analyzer. The introduced traffic is analyzed and collected by the analyzer. The result collected and analyzed by the analyzer of each dispersed cloud node is gathered in the transparent internet cache provisioning server. Herein, an entirety of traffic patterns and local traffic patterns are derived, and in the traffic pattern, the traffic is collected and analyzed per period of time regarding at least some of the address of departing point, address of destination, protocol, uniform resource identifier (URI), traffic type, and frequency.

Using the result obtained through collecting and analyzing, the transparent internet cache provisioning server determines whether or not to install the transparent internet cache in the cloud node (step 215). Herein, the transparent internet cache provisioning server may set whether or not to use the transparent internet cache function per area and selective parameters by the contents service provider's control.

When it is determined to install the transparent internet cache in the cloud node as a result of step 215, the transparent internet cache provisioning server proceeds to step 217.

The transparent internet cache provisioning server determines the branching method in detail with reference to the results analyzed through transparent traffic monitoring (step 217). For example, depending on the collected results, the transparent internet cache provisioning server may allow only HTTP protocol messages to be branched based on responses in a cloud node of a first area, and allow branching to be made according to certain subscriber addresses or destination addresses based on requests in a cloud node of a second area. Furthermore, the transparent interne cache provisioning server may allow branching to be made according to certain subscriber addresses or destination addresses based on requests in a cloud node of a third area, but not use a transparent internet cache in a cloud node of a fourth area. The transparent interne cache provisioning server may determine the branching method according to a service level agreement (SLA) or input signals from contents service operators.

When a branching method is determined, the transparent internet cache provisioning server determines a contents identification method (step 219). The contents identification method may have only URI addresses of contents as subjects to the contents identification method, and identification may be made with reference to hash values of all the URIs. As such, a contents identifier may be determined depending on the contents identification method, and a contents request or frequency of response may be calculated having the contents identifier as the key value.

The transparent internet cache provisioning server determines a transparent internet cache proxy (step 221). The transparent internet cache provisioning server may designate the transparent internet cache server as a proxy server of the origin contents server and determine whether or not to allow the transparent internet cache server to be interlocked with the origin contents server and receive services through messages such as HTTP redirect. Furthermore, the transparent internet cache provisioning server also determines whether or not to operate as a reverse proxy server to be interlocked with the origin contents server and bring contents from the origin contents server for caching of an entirety of data of requested contents at a user's request.

The transparent internet cache provisioning server determines a cache in policy (step 223). The transparent internet cache provisioning server receives a cache in policy, that is a condition for storing in a cache and determines the cache in policy.

The transparent internet cache provisioning server determines a cache replacement policy (step 225). The transparent internet cache provisioning server receives a cache replacement policy to be applied when replacing cache characteristics and determines the cache replacement policy.

The transparent interne cache provisioning server provisions the transparent internet cache (step 227).

The transparent interne cache provisioning server determines whether or not to end the provisioning of the transparent internet cache (step 229). That is the transparent internet cache provisioning server determines whether or not to provision the transparent internet cache in a cloud node located in another area from the area provisioned at step 227.

When it is determined to end the transparent internet cache provisioning without applying the transparent internet cache in the cloud node of another area as a result of determination at step 229, the transparent internet cache provisioning server ends, the transparent interne cache provisioning operation.

However, when it is determined not to end the transparent internee cache provisioning in order to apply the transparent internet cache in the cloud node of another area as a result of determination at step 229, the transparent internet cache provisioning server proceeds to step 215. By doing this, the transparent internet cache provisioning server may perform the transparent interne cache provisioning operate in the cloud node of another area.

By the aforementioned, the transparent internet cache provisioning server may set the transparent internet cache to be suitable to what the service provider requests and perform provisioning differently for each area.

Meanwhile, when it is determined not to install the transparent internet cache in the cloud node, the transparent interne cache provisioning server proceeds to the ending step.

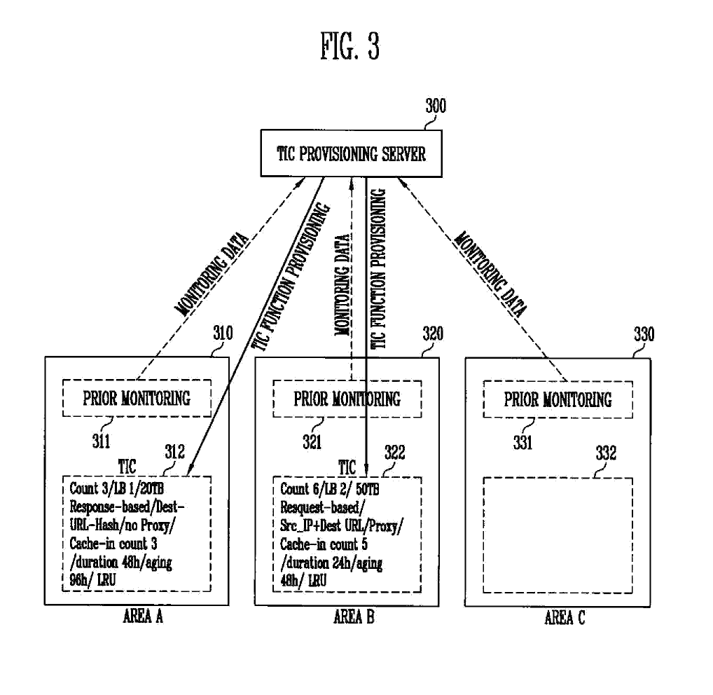

FIG. 3 is a view for explaining an operation of provisioning a transparent internet cache in a dispersed cloud environment according to an embodiment of the present disclosure.

Referring to FIG. 3, a dispersed cloud system includes a transparent internet provisioning server 300, first cloud node 310, second cloud node 320, and third cloud node 330.

Meanwhile, the contents operator is providing the contents delivery network (hereinafter referred to as ‘CON’) service. The contents operator leases and constructs a contents provision server at PoP section of area A, area B, and area C, and provides video services and so forth to the user.

However, the contents operator may embody a cloud-based transparent internet cache in the aforementioned method because of the pressure of cost of connection with an external network and deterioration of service quality.

For this purpose, the transparent internet cache provisioning server 300 may collect data through transparent internet cache monitoring provisioning. Transparent interne cache monitoring 311, 321, 331 are formed through the transparent cache provisioning server 300 in each of the cloud nodes 310, 320, 330 located in each area.

The transparent interne cache provisioning server 300 collects data from each of the cloud nodes 310, 320, 330 through transparent internet cache provisioning. Then, the transparent interne cache provisioning server 300 may obtain the traffic usage pattern through analyzing of the collected data, and according to the obtained traffic usage pattern, transparent interne caches 312, 322 may be embodied in the cloud nodes 310, 320.

The first cloud node 310 located in area A includes a transparent internet cache 321 installed by branching HTTP traffic regarding a certain site, and taking into according the number of servers and cache policy having a URI hash value as an identifier.

The second cloud node 320 located in area B branches contents used in a certain user group. The second cloud node 320 includes a transparent interne cache 322 installed by taking into account a cache policy and replacement policy based on a request for a corresponding traffic.

Meanwhile, in the third cloud node 330 located in area C, a transparent internet cache is not applied. This is illustrated in 332.

By the aforementioned, the transparent interne cache function proposed in the present disclosure demands functions of a 4 layer (L4) to 7 layer (L7) intellectualized in communication network, and the need to include a contents service function as well. Thus, the cache must be installed in a fixed manner.

However, in a dispersed cloud node environment, as high performance computing technology is combined with network technologies, the transparent internet cache function may be dynamically virtualized and embodied in the dispersed cloud environment.

By the aforementioned, the embodied transparent interne cache may be provisioned to the cloud node that has been dispersed dynamically, thereby obtaining high expandability and flexibility. Furthermore, it monitors the traffic characteristics of each of the dispersed areas, and determines service level agreement (SLA) conditions and caching policy of the service users based on the collected and analyzed traffic. Thus, the transparent internee cache function of the characteristics of each area may be provisioned so as to reduce the load and cost of the network, and improve the sensory level of the user.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method for provisioning a transparent internet cache function,
the method comprising:
obtaining a traffic usage pattern by data analyzing from a cloud node in response to receiving a request for transparent internet cache provisioning in a transparent internee cache provisioning server;
when installing a transparent internet cache in the cloud node is being determined,
determining a method for branching traffic;
determining a method for contents identification regarding the traffic branched in the method;
determining whether or not to operate the transparent internet cache as, a proxy server;
generating the transparent internet cache by applying a cache in policy and cache replacement policy; and
provisioning the transparent internet cache to the cloud node.

2. The method according to claim 1,
wherein the obtaining the traffic usage pattern comprises:
provisioning a transparent traffic monitoring function to the cloud node; and
obtaining the traffic usage pattern through data branching and data analyzing by the transparent traffic monitoring function.

3. The method according to claim 2,
wherein the traffic usage pattern comprises information on at least some of an address of departing point, address of destination, protocol, uniform resource identifier (URI), traffic type, and frequency.

4. The method according to claim 1,
wherein the determining a method for branching traffic comprises selecting a number and capacity of the transparent internet cache.

5. The method according to claim 1,
wherein the determining a method for branching traffic comprises selecting an area for selecting the transparent internet cache.

6. The method according to claim 1,
wherein the determining a method for branching traffic comprises selecting one of a request-based mode and response-based mode of the transparent internet cache, and
the request-based mode operates based on a message of request by a client, and the response-based mode operates based on a message of response by a server.

7. The method according to claim 1,
wherein the determining a method for branching traffic comprises determining a redirecting rule for branching the traffic.

8. The method according to claim 1,
wherein the cache in policy is determined based on a same amount of contents demanded during a preset period of time.

9. The method according to claim 1,
wherein the cache replacement policy determines a maximum caching period of the cached contents.

10. A transparent internet cache comprising:
a redirector for redirecting traffic between a client and server;
a contents analyzer for configuring contents identification information through analyzing of contents introduction information included in the traffic;
a cache in handler for storing contents in the cache in response to contents for which cache has been requested being delivered;
a cache out handler for extracting the contents stored in the cache in response to a request for the contents stored in the cache being made;
a server interface for managing session connection with the server, and receiving contents to the provided to the client; and
an end user interface for managing a client session such that the contents transmitted from the server and the contents stored in the cache are provided to the client.

11. The transparent internet cache according to claim 10,
wherein the redirector performs routing in units of flow.

12. The transparent internet cache according to claim 10,
wherein the contents analyzer operates in one of a request-based mode and response-based mode, and
the request-based mode operates based on a message of request by the client, and the response-based mode operates based on a message of response by the server.

13. The transparent internet cache according to claim 10,
wherein the cache in handler prepares meta data for the stored contents, and the meta data is used for repair and maintenance of the cache where the contents are stored.

14. The transparent interne cache according to claim 10,
wherein, when transmitting cached contents to the client, the server interface stops a session with the server, and maintains connection with the client.
